(19) United States
(12) Patent Application Publication
(10) Pub. No.: US 2011/0099523 A1
(43) Pub. Date: Apr. 28, 2011

(54) PRODUCT SELECTION AND MANAGEMENT WORKFLOW

(76) Inventors: Pieter van Zee, Corvallis, OR (US); Marc Frederick Ayotte, Corvallis, OR (US); Phil Manijak, Corvallis, OR (US); Russell Mull, Corvallis, OR (US); Michael R. Wilson, Corvallis, OR (US)

(21) Appl. No.: 12/607,675

(22) Filed: Oct. 28, 2009

(51) Int. Cl. G06F 3/048

(52) U.S. Cl. 715/838

(57) ABSTRACT

A method includes causing, in a first frame of a user interface, a display of thumbnails each corresponding to a different digital image. With the thumbnails displayed in the first frame, a display of a series of product controls is caused to be displayed. Upon a user's selection of a first one of the product controls, the thumbnails are modified to a first product preview format corresponding with the first product control. Upon the user's selection of a second one of the product controls, the thumbnails are modified to a second product preview format corresponding with the second product control.

### BACKGROUND

Consumers often order single and multi-image products via kiosks and web services. Single image products include image prints of various sizes. Multi-image products include collage posters, photo books, and the like. To the consumer's chagrin, the kiosks and web services utilize separate workflows for ordering single image and multi-image products. In other words, the consumer follows a first set of tasks to order a single image prints and a second set of tasks to order multi image products.

### DRAWINGS

FIGS. 1 and 2 depict exemplary environments in which embodiments may be implemented.

FIGS. 3-13 depict exemplary screen views of a user interface according to embodiments.

FIG. 14 depicts an exemplary product selection and management system according to an embodiment.

FIGS. 15 and 16 are block diagrams of environments in which the system of FIG. 10 may be implemented.

FIGS. 17 and 18 are flow diagrams depicting steps take to implement various embodiments.

### DETAILED DESCRIPTION

Various embodiments described below operate to provide a common workflow for selecting and editing single and multi image products. The single workflow enables a user work with a common set of digital images to select and manage various products including, but not limited to, photo prints of various sizes, collage posters, calendars, photo books, and the like.

The following description is broken into sections. The first, labeled “Environment,” describes exemplary environments in which embodiments may be implemented. The second section, labeled “Workflow,” describes a series of exemplary screen views depicting a common workflow for selecting and editing single and multi-image products. The third section, labeled as “Components”, describes physical and logical components of various embodiments. The last section, labeled “Operation,” describes steps taken to implement various embodiments.

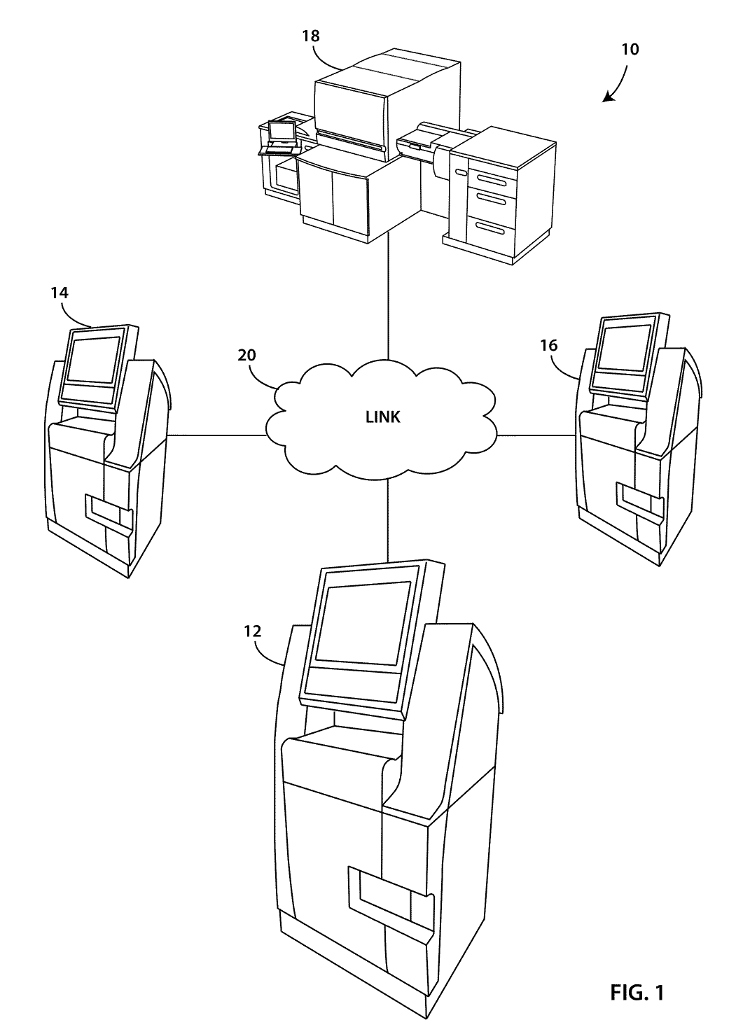

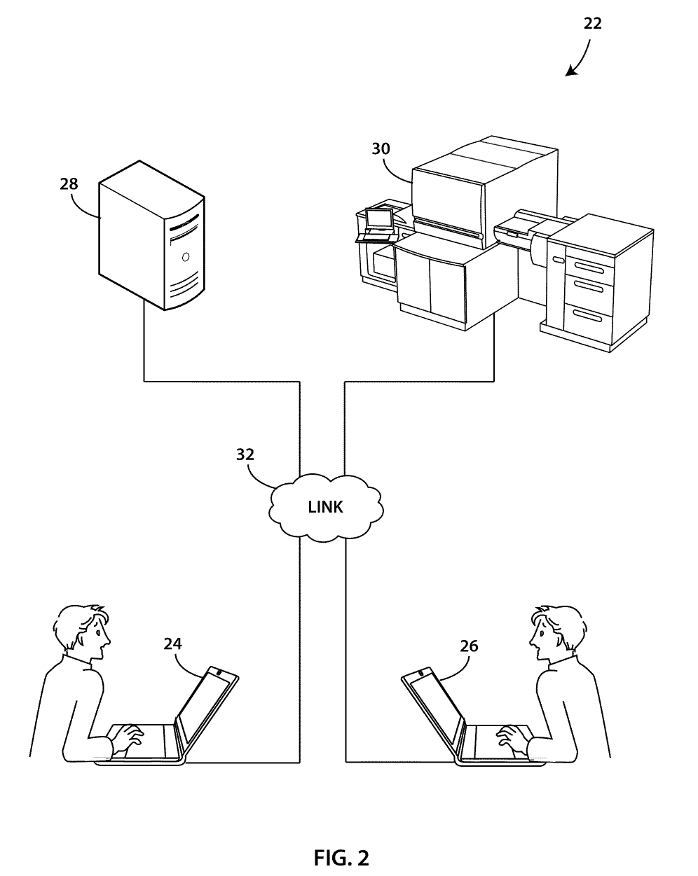

ENVIRONMENT: FIGS. 1-2 depict exemplary environments in which embodiments may be implemented. Starting with FIG. 1, environment 10 includes kiosks 12, 14, and 16 and production service 18 interconnected via link 20. Kiosks 12-16 each represent a computing device through which a user can select, edit, and order single and multi-image products. Each kiosk 12-16 presents a user interface via a display device. Often this display device incorporates a touch screen allowing the user to manipulate various controls with the touch or slide of a finger. Accessing digital images via a memory card or the Internet, programming on each kiosk 12-16 allows a user to select from among the digital images, edit selected digital images, and order single and multi-image products populated with selected digital images.

Production service 18 represents generally any device or collection of devices capable of producing single and multi-image products ordered via kiosks 12-16. Link 20 represents generally one or more of a cable, wireless, fiber optic, or remote connection via a telecommunication link, an infrared link, a radio frequency link, or any other connector or system that provides electronic communication. Link 20 may represent an intranet, the Internet, or a combination of both. The paths followed by link 20 between kiosks 12-16 and production service 18 as depicted in FIG. 1 represent the logical communication paths between these devices, not necessarily the physical paths between the devices.

FIG. 2 depicts another environment 22 in which embodiments may be implemented. Environment 22 is shown to include client devices 24 and 26, server device 28, and production service 30 interconnected via link 32. Client devices 24 and 26 represent generally any computing devices capable of visually presenting a graphical user interface to a user and receiving user input via a touch screen, mouse, and/or a keyboard. Server device 28 represents generally any computing device capable of serving content to client devices 24, 26 that enable users to order single and multi-image products. Accessing digital images from client devices 24 or 26 or stored locally, server device 28 serves web pages or other content enabling users to select from among the digital images, edit selected digital images, and order single and multi-image products populated with selected digital images.

Production service 30 represents generally any device or collection of devices capable of producing single and multi-image products ordered via client devices 24, 26 and server device 28. Link 32 represents generally one or more of a cable, wireless, fiber optic, or remote connection via a telecommunication link, an infrared link, a radio frequency link, or any other connector or system that provides electronic communication. Link 32 may represent an intranet, the Internet, or a combination of both. The paths followed by link 32 between devices 24-30 as depicted in FIG. 2 represent the logical communication paths between these devices, not necessarily the physical paths between the devices.

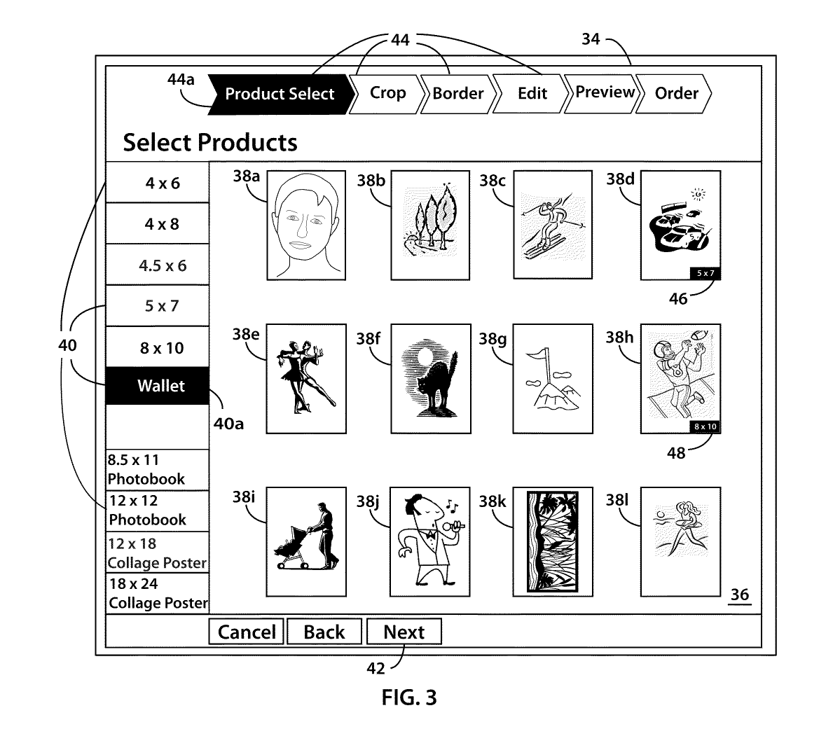

WORKFLOW: FIGS. 3-13 depict exemplary screen views of a user interface 34 through which a user can order single and multi-image products via a common workflow. The term workflow as used herein refers to a defined series of tasks for producing a final outcome. From a user's perspective, the tasks involve a user's selection from among various single and multi-image products as well as the user's selection of digital images for populating those products. Additional tasks include editing each instance of a selected digital image used to populate a given product. The final outcome is the ordering of user selected and populated single and multi-image products. Ordering, for example, can include sending a job or jobs to a production service requesting the production of one or more user selected, populated, and edited products.

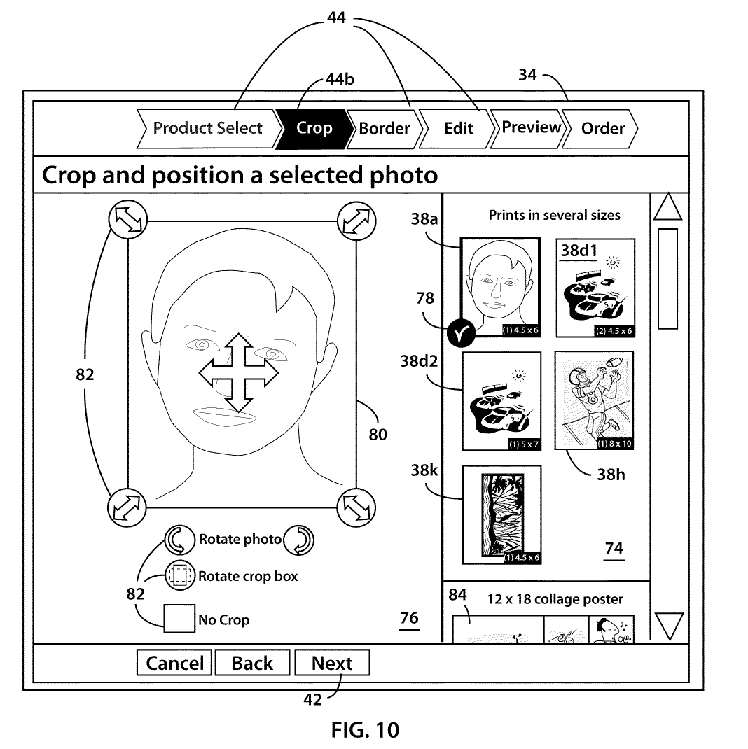

Starting with FIG. 3, user interface 34 is shown to include frame 36. The term frame as used refers to a defined area within user interface 34 for displaying text and graphics. As will be seen with respect to FIGS. 10-13, user interface 34 includes multiple frames. Some are displayed together at the same time while others are displayed sequentially as a user proceeds through the workflow. Displayed within frame 36 are thumbnails 38a-38I, referred to collectively as thumbnails 38. Each thumbnail 38 is a user selectable control providing a visual representation of a given digital image or images. In other words, a user selects a given digital image by selecting a corresponding thumbnail 38. Frame 36 is also shown to include product controls 40 for selecting from among a number of single image products.

User interface 34 includes workflow control 42 and workflow indicator 44. Workflow control 42 represents generally a user selectable control or controls enabling a user to sequence through various tasks of the workflow. Workflow indicator 44 represents a graphic or textual indication of an active task within the workflow. In the example of FIG. 3, task 44a is highlighted within task indicator 44. Task 44a involves product selection. To select a product, the user first selects a desired product control 40 and then a desired thumbnail image for a single image product or, in some instances, multiple thumbnails for a multi-image product.

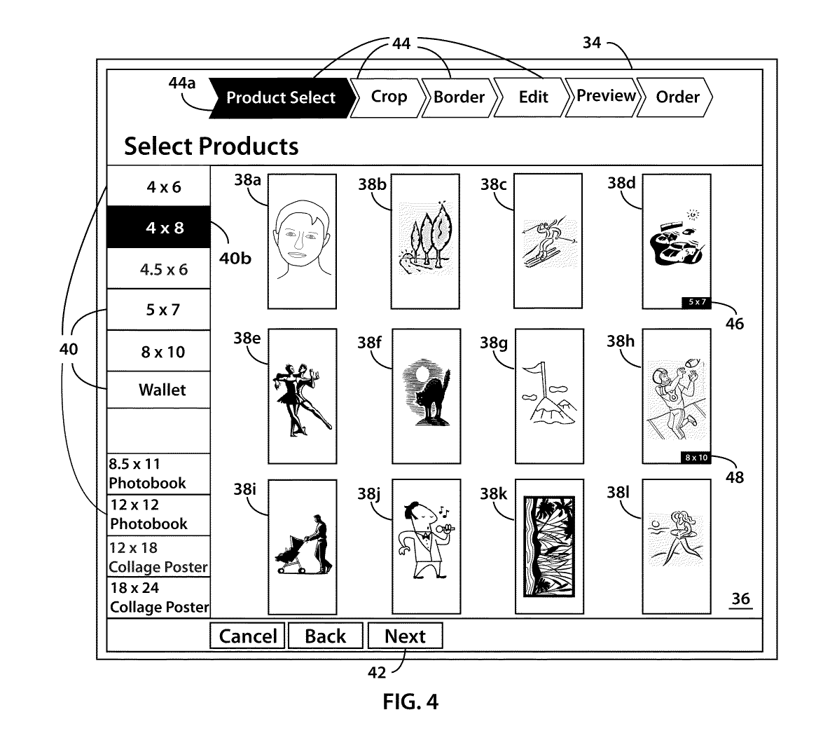

Here a user has selected product control 40a corresponding to wallet prints. While no thumbnails 38 have been selected for wallet single image prints, thumbnails 38 have been generated or modified to a product preview format for wallet size prints. A product preview format. As used herein, is a configuration in which a thumbnail's appearance corresponds to a particular product. For example, a thumbnail's aspect ratio is set match that of the selected product. Thumbnail 38d has been modified with marking 46 to indicate that the user has previously selected the corresponding digital image to be used in producing a 5×7 single image print. Thumbnail 38h has been modified with marking 48 to indicate that the user has previously selected the corresponding digital image to be used in producing an 8×10 single image print. Moving to FIG. 4, the user has selected product control 40b corresponding to 4×8 single image prints. While no thumbnails 38 have been selected, thumbnails 38 have been modified to a product preview format for 4×8 prints.

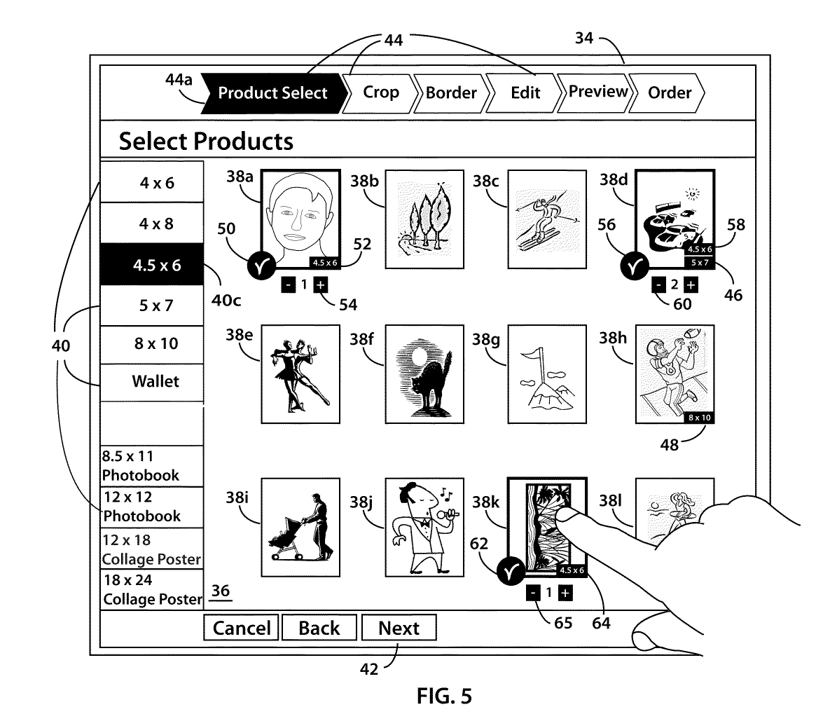

Moving to FIG. 5, the user has selected product control 40c corresponding to 4.5×6 single Image prints. As a consequence, f thumbnails 38 are modified to a product preview format for 4.5×6 prints. The user has selected thumbnails 38a, 38d, and 38k. As a result, thumbnail 38a has been modified with markings 50-54, thumbnail 38d has been modified with markings 56-60, and thumbnail 38k has been modified with markings 62-66. Markings 50, 56, and 62 each provide an indication that a given thumbnail 38a, 38d, and 38k has been selected with respect to currently selected product control 40a. Markings 52, 58, and 64 indicate that the user has selected the corresponding digital images to be used in producing a 4.5×6 single image print. Markings 54, 60, and 66 represent user selectable controls for selecting a number of 4.5×6 single image prints for each corresponding digital image. Here, the user has indicated a desire for two 4.5×6 single image prints for the digital image represented by thumbnail 38d and one 4.5×6 print for each of the others.

With respect to FIGS. 3, 4 and 5, the user's selection of the 8×10 product control 40 followed by a selection of thumbnail 38h updated a list, often referred to as an electronic shopping cart, to include an order for an 8×10 single image print of the digital image represented by thumbnail 38h. The user's selection of the 5×7 product control 40 followed by the selection of thumbnail 38d updated the list to include an order for a 5×7 single image print of the digital image represented by thumbnail 38d. The user's selection of the 4.5×6 product control 40a followed by the selection of thumbnails 38a and 38k updated the list to include an order for a one 5×7 single image print for each of the digital images represented by thumbnails 38a and 38k. The user's selection of product control 40a, thumbnail 38d, and control 60 updated the list to include an order for two 4.5×6 single image prints of the digital image represented by thumbnail 38d.

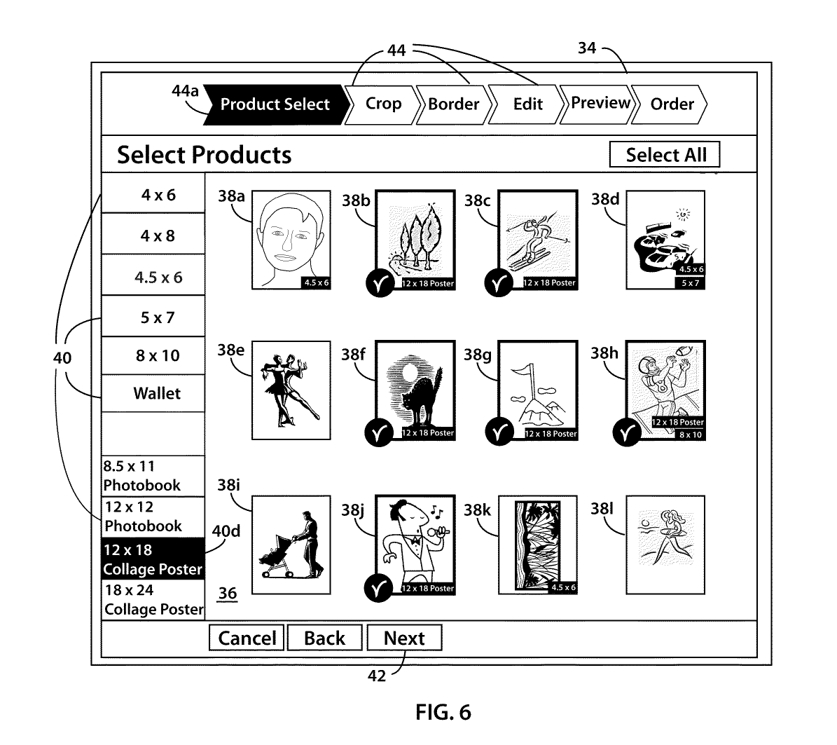

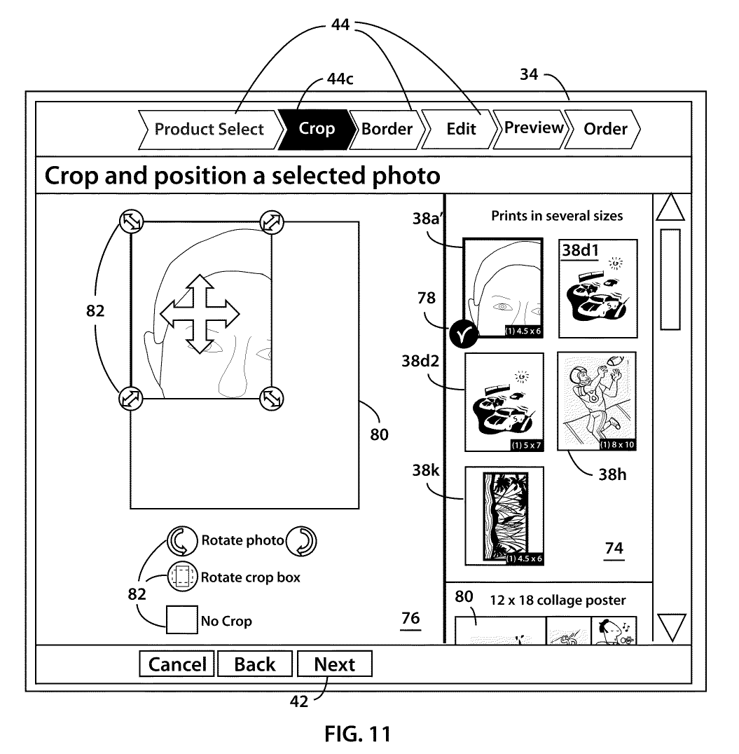

Moving on to FIG. 6, the user has selected control 40d corresponding to a multi-image product—in particular—a 12×18 collage poster. As will become more apparent with the discussion of FIGS. 10 and 11, images selected to populate a multi-image product can be variably sized. For this reason, upon the user's selection of a multi-image product control such as 40d, thumbnails 38 are modified to a default product preview format corresponding to product control 40d. With product control 40d selected, the user selects from among thumbnails 38a-38i to populate product the multi-image product. Here the user has selected thumbnails 38b, 38c, 38f, 38g, 38h, and 38j. The selection of product control 40d followed by the selection of thumbnails 38b, 38c, 38f, 38g, 38h, and 38j updated the list, discussed above, to include an order for a 12×18 collage poster populated with digital images corresponding to the selected thumbnails.

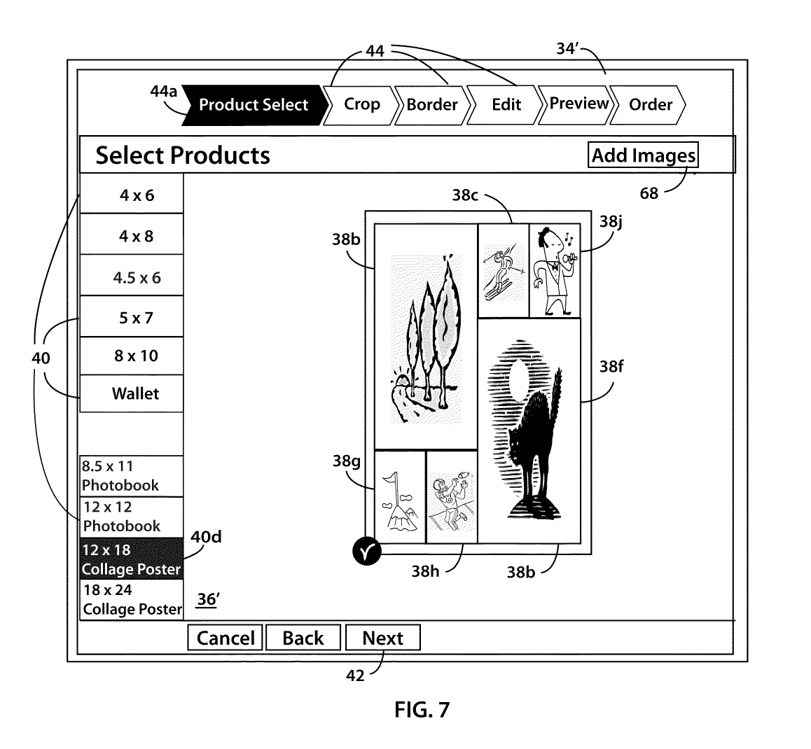

FIGS. 7-9 depict an alternative implementation of a user interface for selecting multi-image products referenced as user interface 34′. Starting with FIG. 7, the user has selected product control 40d for a 12×18 Collage Poster. Instead of containing separate individual thumbnails 38 as in FIG. 6, user interface 34′ includes, within frame 36′, selected ones or all of thumbnails 38 are grouped in a product preview format for a 12×18 collage poster. Here, the product preview format has a 12×18 aspect ratio and includes a collage of individual thumbnails. In this example, that collage includes thumbnails, 38b 38c, 38f, 38g, 38h, and 38j each modified to a product preview format for a given image as it will appear in the multi-image product. Selection of product control 40d followed by a selection of thumbnail 38m updated the list to include an order for a 12×18 collage poster populated with two or more images. At this point in the workflow, the images selected to populate the poster may have been selected automatically. The particular layout of the collage 38m depends in part on the number of images selected to populate the multi-image product.

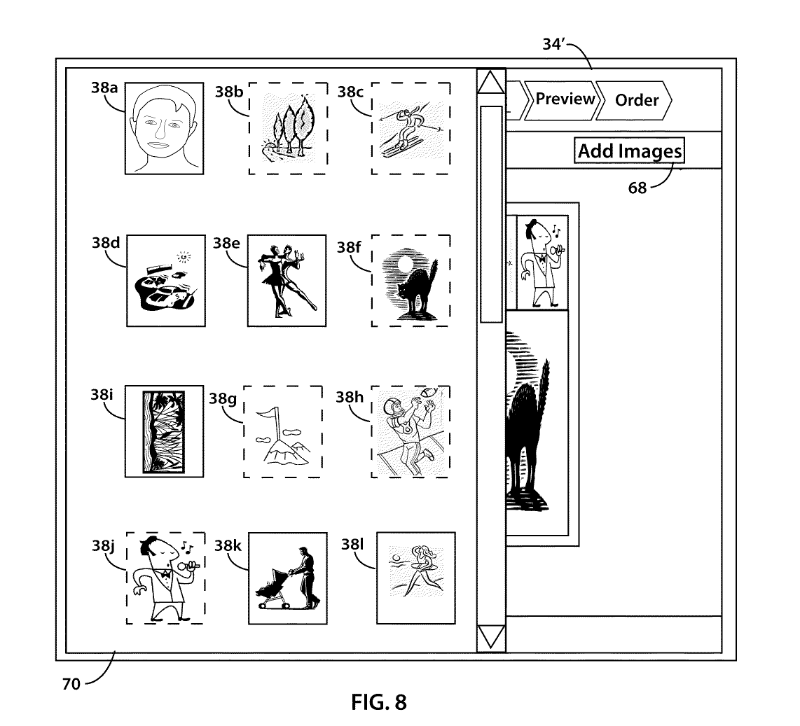

Frame 36′ is shown to include Add Images control 68. Upon manipulation of control 68, the user is presented with a display for selecting images to populate the selected multi-image product. In FIG. 8, a user has selected control 68 causing user interface 34′ to include image overlay 70. Image overlay 70 includes image thumbnails 38a-38I. Image thumbnails for those images already selected (automatically or otherwise) to populate the multi-image product are distinguished from the others. Here, those thumbnails are shown in broken lines. However, those thumbnails may still be active for selection allowing the same image to be used more than once to populate the multi-image product. In this example, the user has selected thumbnail 38a causing overlay 70 to close. While not shown, collage 38m (FIG. 7) would be updated to include thumbnail 38a.

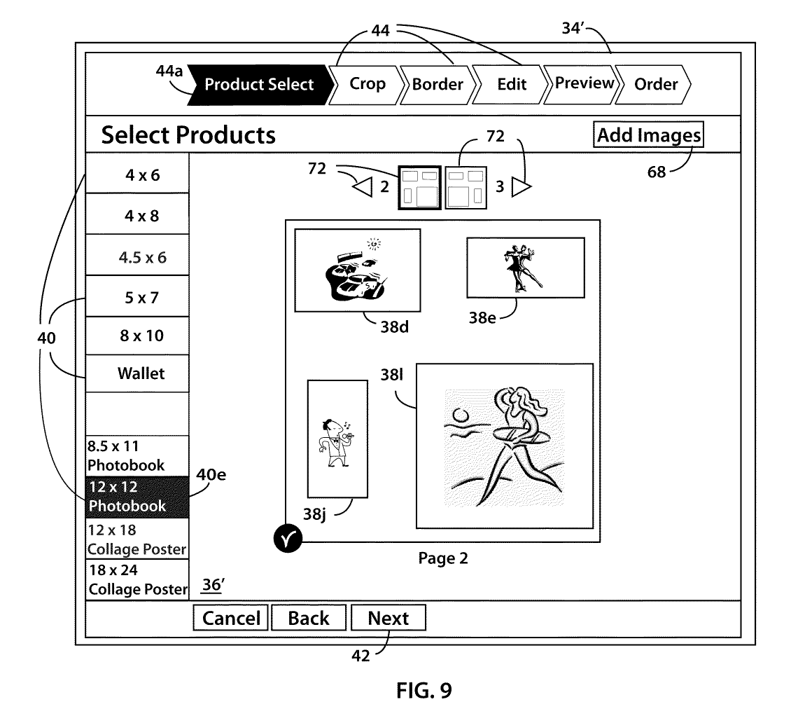

Moving to FIG. 9, the user has selected product selection control 40e for a 12×12 photo book. Again, instead of containing separate individual thumbnails 38 as in FIG. 6, user interface 34′ includes, within frame 36′, selected ones or all of thumbnails 38 are grouped in a product preview format for a page of a 12×12 photo book. Since, the selected multi-image product is also a multi-page product, user interface 34′ includes page browsing controls 72. Selection of product selection control 40e followed by manipulation of page browsing controls 72 alters an arrangement of thumbnails 38 to a product preview format of a selected page of the multi-page product. In FIG. 9, the product preview format has a 12×12 aspect ratio and includes an arrangement of individual thumbnails. At this point in the workflow, the images selected to populate the photo book may have been selected automatically. In this example, those images are represented by thumbnails, 38d, 38e, 38j, and 38l. To add images, the user manipulates control 68 causing the display of an overlay as depicted in FIG. 8.

Looking back on FIGS. 3-9, one can see that in each instance, user interface 34, 34′ includes thumbnails each corresponding to given image. In FIGS. 3-5, each thumbnail also corresponds to a single image print. In FIGS. 6-9, the thumbnails are arranged together in a multi-image product such as a collage poster or a photo books. In all instances, the thumbnails are presented in a product preview format corresponding to a selected product. Where the product is a single image product, the thumbnails have an aspect ratio matching that of the product. Where the product is a multi-image product, the placement, relative size, aspect ratio of each thumbnail is set to match the placement, aspect ratio, and relative size of a corresponding image that will appear in the product.

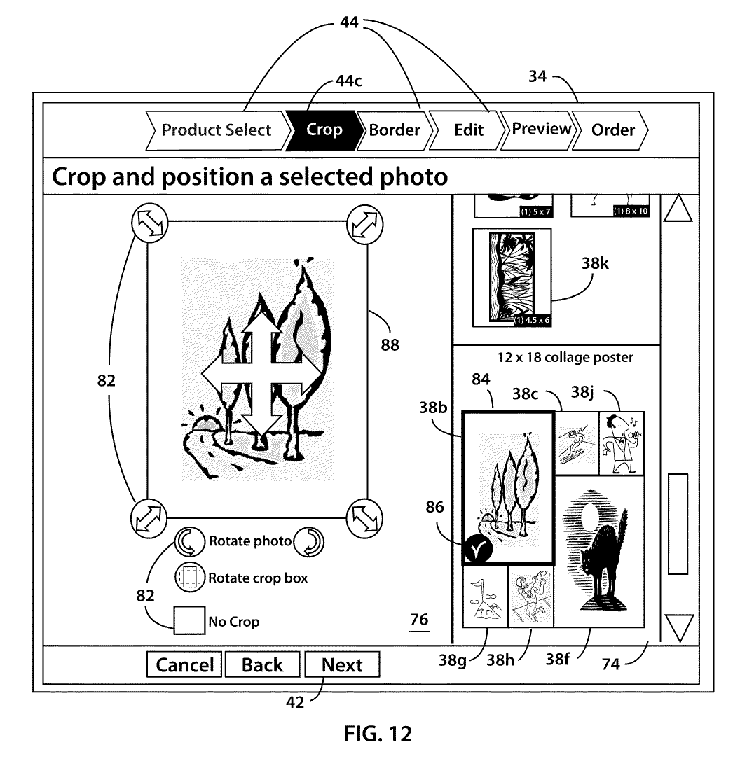

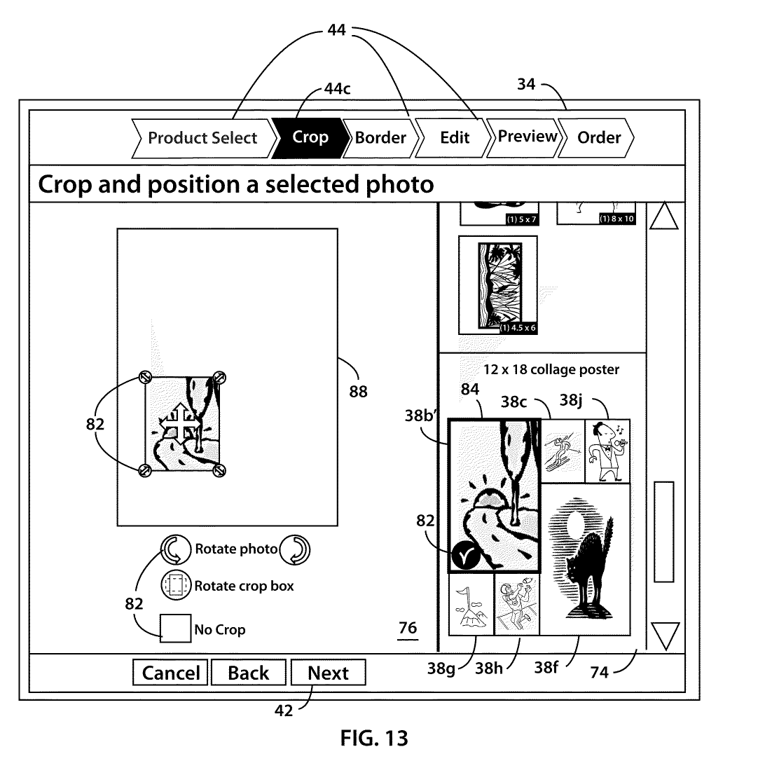

Assuming the user has finished selecting products, the user selects workflow control 42 stepping ahead to the next task 44b in the workflow. Referring to FIGS. 10-15, that next task involves editing each instance of a selected digital image used to populate a given product on the list. In the example of FIG. 10, editing includes cropping and positioning. Replacing frame 36, user interface 34 now includes frames 74 and 76. Frame 74 includes an individual thumbnail for each single image product included in the list (seen best in FIGS. 10 and 11) and a grouping of thumbnails for each multi-image product on the list (seen best in FIGS. 12 and 13). Frame 76 includes a product preview image corresponding to a thumbnail selected in frame 74. Referring to FIGS. 10 and 11, within frame 74, each individual thumbnail for a single-image product includes a representation of the digital image being used to populate that given single-image product. Referring to FIGS. 10 and 11, each grouping of thumbnails for a multi-image product, includes individual thumbnails for each digital image used to populate that multi-image product.

In the example of FIG. 10, frame 74 includes thumbnails 38a, 38d1, 38d2, 38h, and 38k each corresponding to a single image product on the list as selected by the user in the previous workflow task 44a. While not completely visible, frame 74 also includes a grouping 84 of thumbnails corresponding to the multi-image product selected by the user in the previous workflow task 44b. Here, the user has selected thumbnail 38a as indicated by marking 78. As a result an editable product preview image 80 is displayed in frame 76.

Displayed with editable preview image 80 are controls 82 allowing the user to crop and position the digital image for a given single image product corresponding to the thumbnail 38a selected in frame 74. Referring to FIG. 11, once the user has cropped and positioned the digital image via the editable preview image 80, the single image product is modified accordingly. The corresponding thumbnail 38a′ in frame 74 is modified to provide an accurate preview of the modified single image product.

Moving to FIG. 12, the user has scrolled frame 74 to reveal grouping 84 of thumbnails corresponding to the multi-image product selected in workflow task 44b. Grouping 84 includes individually selectable thumbnails 38b, 38c, 38f, 38g, 38h, and 38j each corresponding to digital image selected by the user to populate the multi-image product. In the example of FIG. 10, the user has selected thumbnail 38b from grouping 84 as indicated by marking 86. As a result, editable preview image 88 is displayed in frame 76. Referring to FIG. 11, once the user has cropped and positioned the digital image via the editable preview image 88, the multi-image product is modified accordingly. The corresponding thumbnail 38b within grouping 84 in frame 74 is modified to provide an accurate preview of the modified multi-image product.

Via the exemplary user interface of FIGS. 3-13 a user is able to manage and order single and multi image products in a single workflow. Within that workflow, the user can select desired image or images for populating each product being ordered. The user can also edit each instance of an image selected to populate a given product. For example, an image selected to populate a single image print may be edited one way while another instance of that same image selected to populate a cell in a collage poster may be edited in another manner.

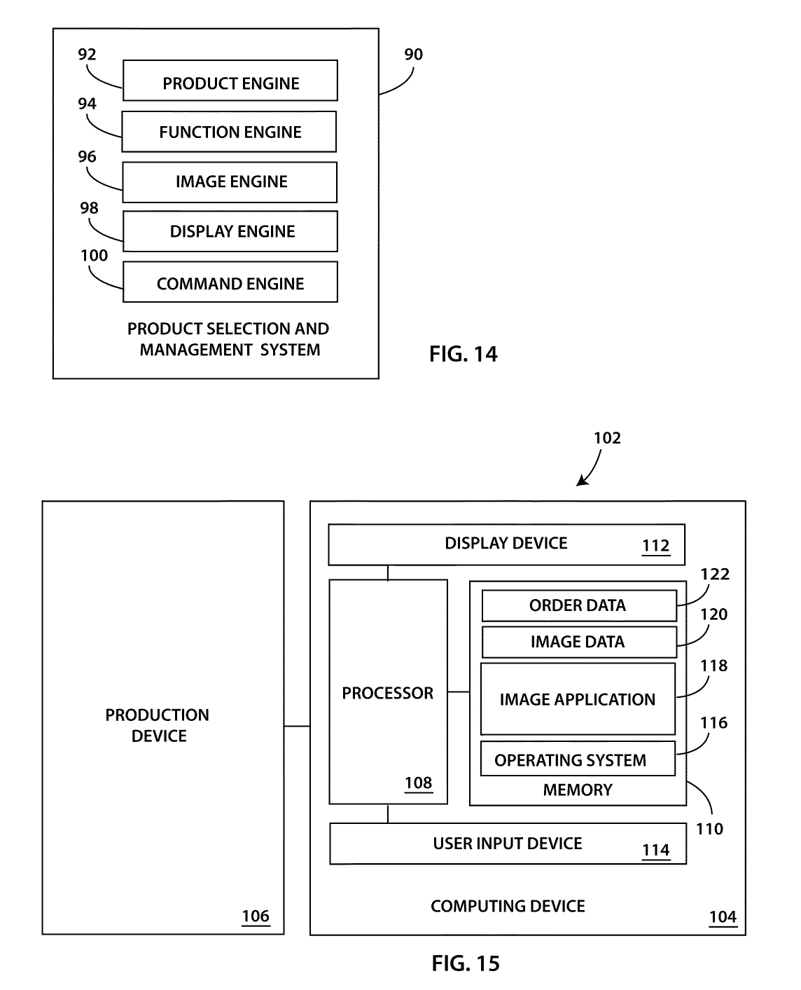

COMPONENTS: FIG. 14 depicts various physical and logical components that function as product selection and management system 90. System 90 is shown to include product engine 92, function engine 94, image engine 96, display engine 98, and command engine 100. Product engine 92 represents generally any combination of hardware and programming for defining the single and multi-image products available for ordering. Definitions for the single image products can define print sizes and the available media on which the images can be formed. Such media can include photo paper, coffee mugs, clothing, and the like. Thus, one single image product may include an eight by ten image formed on photo paper. Another single image product may be defined as four by four image formed on a mouse pad.

Function engine 94 represents generally any combination of hardware and programming configured to define one or more functions for editing images selected to populate a product or products. Such functions can include cropping, positioning, color management, red-eye removal, adding borders, and the like.

Image engine 96 represents generally any combination of hardware and programming configured to generate thumbnails from a set of digital images. Upon selection of a product control, image engine 96 is responsible for modifying the thumbnails to a product preview format for the selected product control. Image engine 96 is also responsible for generating and modifying thumbnails to be displayed in various frames of a user interface. Initially, image engine 96 is responsible for generating a first set of thumbnails for each of a set of digital images available to a user. Upon selection of a thumbnail from the first set, image engine 96 is responsible for modifying that thumbnail to indicate its selection for populating a given product with a corresponding digital image. FIGS. 3-6, discussed above, provide examples.

Image engine 96 is responsible for generating a second set of thumbnails. The second set includes a thumbnail for each instance of a digital image selected to populate a single image product and groupings of thumbnails for digital images selected to populate one or more multi-image products. Upon selection of a thumbnail from the second set, image engine 96 is responsible generating a corresponding editable preview image. Image engine 96 modifies a thumbnail selected from the second set to reflect the manner in which the editable preview image has been manipulated by a user. FIGS. 10-13, discussed above, provide examples.

Display engine 98 represents generally any combination of hardware and programming configured to cause, in accordance with a current workflow task, the display thumbnails generated and modified by image engine 96 in a given frame of a user interface. Display engine 98 is also responsible for causing the display of product controls, workflow controls, and editable product preview images as indicated by the current workflow task. FIGS. 3-13, discussed above, provide examples.

Command engine 100 represents generally any combination of hardware and programming configured to detect a user's selections from among the displayed thumbnails, product controls, and workflow controls. Command engine 100 is responsible for updating a list to identify a products corresponding to a detected selection of a product control and a thumbnail or thumbnails. For example, a user interface presented on a touch screen display device may include a frame containing a set of user selectable thumbnails each corresponding to a digital image and a set of product controls. A user, via the touch screen, selects a product control and a given thumbnail. Command engine 100 directly or indirectly detects the user's selections and updates a list to identify a product that corresponds to the user's selections. Such a product may be a single image product populated with a digital image represented by the selected thumbnail. The user may select another product control and then select a set of thumbnails. Where that product control corresponds to a multi-image product, command engine 100 updates the list to identify a multi-image product populated with digital images represented by the selected set of thumbnails. Where that product control corresponds to a single image product, command engine 100 instead updates the list to identify a single image product for each selected thumbnail in the set.

Upon selection of a product control, image engine 96 modifies the thumbnails of the first set to a product preview format for that selected product control. Image engine 96, upon a user's selection of a product control and a thumbnail, modifies that thumbnail to reflect the selection of the thumbnail and product control. The modification can include a marking indicating that the thumbnail is currently selected. The modification can also indicate that the digital image corresponding to the selected thumbnail has been selected to populate a product identified by the selected product control. FIGS. 5 and 6, discussed above, provide examples.

As noted, display engine 98 is configured to display a workflow control. Upon a user's selection of the workflow control, display engine 98 causes a display of the second set of thumbnails generated by image engine 96 in a second frame of the user interface. Upon a user's selection of a thumbnail in the second frame, display engine 98 and causes, in a third frame of the user interface, a display of a corresponding editable preview image generated by image of the digital image represented by that thumbnail. FIGS. 10-13, discussed above, provide examples.

System 90 of FIG. 14 may be implemented in a number of environments such as environment 102 of FIG. 15. Environment 102 includes computing device 104 and production device 106. Computing device 104 may be a general purpose computer, a specialized kiosk, or an integrated sub-system of production device 106. Production service 106 represents generally any device or collection of devices capable of producing single and multi-image products ordered via computing device 104.

Computing device 104 is shown to include processor 108, memory 110, display device 112, and user input device 114. Processor 108 represents generally any device capable of executing program instructions stored in memory 110. Memory 110 represents generally any memory configured to store program instructions and other data. Display device 112 represents generally any display device capable of displaying a graphical user interface at the direction of processor 108. User input device 114 represents generally any device such as a mouse, keyboard, or a touch screen through which a user can interact with a user interface presented via display device 112.

Memory 110 is shown to include operating system 116, image application 118, image data 120, and order data 122. Operating system 116 represents generally any software platform on top of which other programs or applications such as image application 118 run. Examples include Linux® and Microsoft Windows®. In this example, operating system 116 includes drivers for controlling the operation of components 112 and 114. In particular, these drivers translate generic commands into device specific commands capable of being utilized by components 112 and 114.

Image application 118 represents generally any programming that, when executed, implements the functionality of engines 92-100 of FIG. 14. Image data 120 represents the digital images image application 150 acts upon. Order data 122 represents data identifying single and multi image products ordered by a user. As noted above, the various components of system 90 of FIG. 14 include combinations of hardware and programming. With respect to FIG. 15, the hardware components may be implemented though processor 108. The programming elements may be implemented via image application 118. In particular, the workflow for selecting and editing single and multi-image products may be presented via a user interface generated and managed by image application 118.

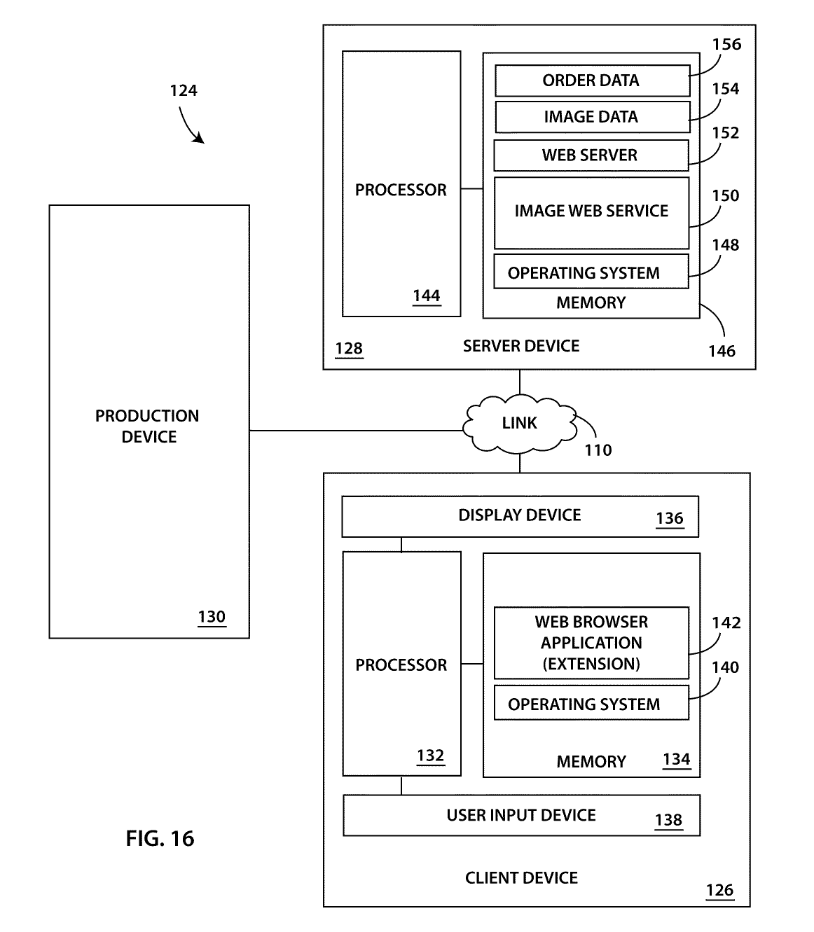

System 90 of FIG. 14 may be implemented in environment 124 of FIG. 16. Environment 124 includes client device 122, server device 128, and production device 130 interconnected via link 107. Client device 126 may be a general purpose computer, a specialized kiosk, or an integrated sub-system of production device 130. Server device 128 represents any computing device capable of serving content via link 110. Production device 130 represents generally any device or collection of devices capable of producing single and multi-image products ordered via computing device client device 126 and server device 128.

Client device 126 is shown to include processor 128, memory 134, display device 136, and user input device 138. Processor 132 represents generally any device capable of executing program instructions stored in memory 134. Memory 134 represents generally any memory configured to store program instructions and other data. Display device 136 represents generally any display device capable of displaying a graphical user interface at the direction of processor 132. User input device 138 represents generally any device such as a mouse, keyboard, or a touch screen through which a user can interact with a user interface presented via display device 136.

Memory 134 is shown to include operating system 140, web browser application 142. Operating system 140 represents generally any software platform on top of which other programs or applications such as web browser application 142 run. Examples include Linux® and Microsoft Windows®. In this example, operating system 116 includes drivers for controlling the operation of components 136 and 138. In particular, these drivers translate generic commands into device specific commands capable of being utilized by components 136 and 138. Web browser application 142 represents generally any programming that, when executed by processor 132, requests and causes a display of content served by server device 128. Web browser application 142 is also responsible for communicating data indicative of user input back to server device 128.

Server device 128 is shown to include processor 144 and memory 146. Processor 144 represents generally any device capable of executing program instructions stored in memory 146. Memory 146 represents generally any memory configured to store program instructions and other data. Memory 146 is shown to include operating system 148, image web service 150. Web server 152, image data 154, and order data 156. Operating system 148 represents generally any software platform on top of which other programs or applications such as service 150 and server 152 run. Examples include Linux® and Microsoft Windows®.

Image web service 150 in combination with web server 152 represents generally any programming that, when executed, implements the functionality of engines 92-100 of FIG. 14. Image data 154 represents the digital images image web service 150 acts upon. Order data 156 represents data identifying single and multi image products ordered by a user and indicated by communications received by web server 152 from client device 126.

As noted above, the various components of system 90 of FIG. 14 include combinations of hardware and programming. With respect to FIG. 14, the hardware components may be implemented though processor 144. The programming elements may be implemented via image web service 150 and web server 152. In particular the workflow for selecting and editing single and multi-image products may be presented and managed via content generated by image web service 150 and served by web server 152.

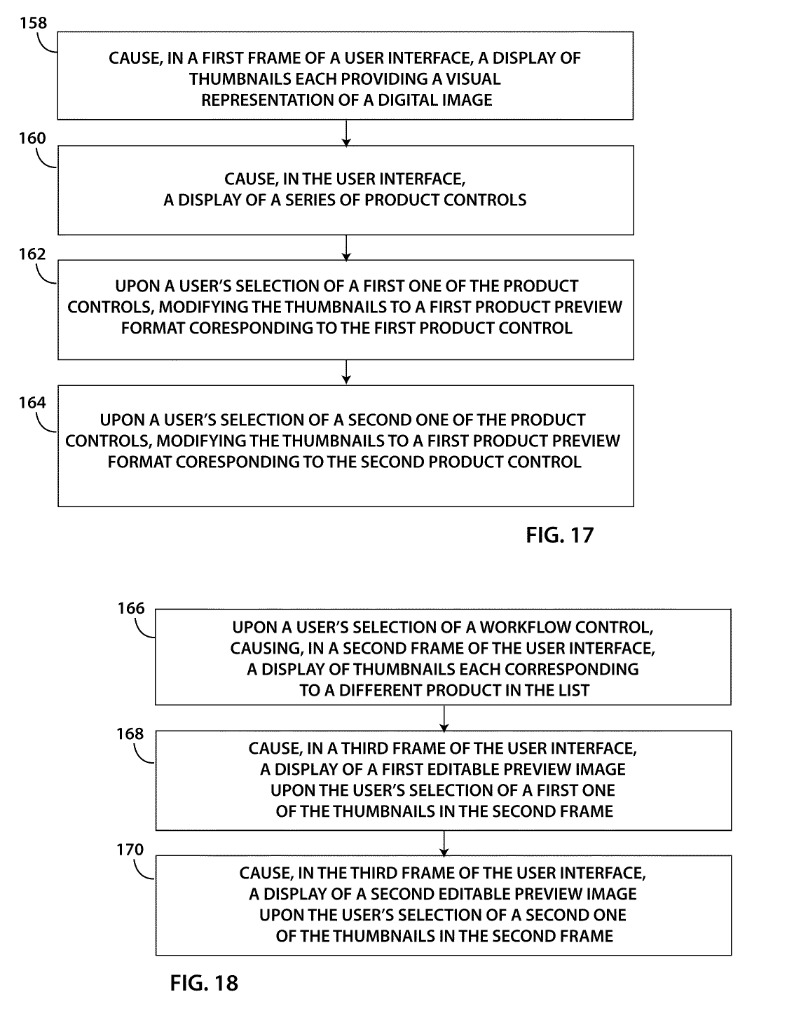

OPERATION: FIGS. 17-18 are exemplary flow diagrams of steps taken to implement various embodiments providing a common workflow for selecting and editing single and multi image products. In discussing FIGS. 15-16, reference may be made to the diagrams of FIGS. 1-16 to provide contextual examples. Implementation, however, is not limited to those examples.

Starting with FIG. 17, a method includes causing, in a first frame of a user interface, a display of a thumbnails each corresponding to a digital image (step 158). Along with the thumbnails, a series of product controls are also caused to be displayed in the user interface (step 160). Referring back to FIG. 14, display engine may be responsible for implementing steps 158-160. FIG. 3 depicts an exemplary user interface 34 in which thumbnails 38 are displayed in a first frame 36. User interface 34 also includes a series of product controls 40.

Continuing with FIG. 15, upon a user's selection of a first one of the product controls, the thumbnails are modified to a first product preview format that corresponds with the first product control (step 162). For example, the first product control may correspond to a 4.5×6 single image product. As a consequence, the thumbnails are modified to have a 4.5×6 aspect ratio in step 162. Upon a user's selection of a second one of the product controls, the thumbnails are modified to a second product preview format that differs from the first product preview format (step 164). For example, the second product control may correspond to a photo collage of a particular size. As a consequence, the thumbnails may be arranged into a collage with each thumbnail sized and positioned to fill a particular cell of that collage. Referring back to FIG. 10, image engine 96 may be responsible for implementing steps 162 and 164.

Looking back to FIG. 4, a user has selected a first product control 40b which corresponds to a 4×8 single image photo. As a consequence, image engine 96 has modified thumbnails 38 to a first product preview format where each thumbnail has a 4×8 aspect ratio that corresponds to product control 40b. Looking to FIG. 7, the user has selected a second product control 40d corresponding to a 12×18 collage poster. As a consequence, image engine 96 has modified thumbnails 38 to a second product preview format corresponding to product control 40d.

Upon a user's selection of the first product control in step 162 followed by a selection of a first thumbnail, a list is updated to include a first product corresponding to the first product control and the first thumbnail. Upon a user's selection of the second product control in step 164 followed by a selection of a second thumbnail, the list is updated to identify a second product corresponding to the second product control and the second thumbnail. With respect to steps 162 and 164, a given thumbnail (such as thumbnail 38d) could serve as both the first and second thumbnails. Looking to FIG. 7, product control 40d may serve as the second product control of step 164, while thumbnails 38b, 38c, 38d, 38f, 38g, 38h, and 38j, as a group, serve as the second thumbnail or, more accurately, as second thumbnails.

It is noted that a thumbnail may be selected by selecting the thumbnail itself via a touch screen or through the use of a pointing device. In other cases, a thumbnail may be associated with a control such as a push button, ratio button, and the like. In such cases, the thumbnail may be selected through a users manipulation of the associated control.

Once, in steps 162 and 164, the user has selected a given product control and a given thumbnail, the selected thumbnail is modified to reflect the selection of the given product control. Thus in step 162, the first thumbnail is modified to indicate the selection of the first product control. The second thumbnail is modified to indicate the selection of the second product control. Referring back to FIG. 14, image engine 96 may be responsible for updating the thumbnails. Looking at FIG. 5, thumbnails 38a, 38d, and 38k have each been modified to indicate the selection product control 40a. In FIG. 6, thumbnails 38b, 38c, 38d, 38f, 38g, 38h, and 38j have each been modified to reflect the selection of product control 40d.

The method depicted in FIG. 17 continues in FIG. 18. Upon a user's selection of a workflow control, a thumbnail corresponding to each product included in the list of steps 162 and 164 is caused to be displayed in a second frame of the user interface (step 166). Referring to FIG. 14, display engine 98 may be responsible for implementing step 166. Looking back to FIG. 10, a user's selection of workflow control 42 moved the workflow to a crop task 44c. User interface 34 now includes a second frame 74 containing thumbnails 38a, 38d1, 38d2, 38h, 38k, and grouping 84 identifying products added to the list.

Continuing again with FIG. 18, upon the user's selection of a first thumbnail in the second frame, a first editable preview image is displayed in a third frame of the user interface (step 168). Upon the user's selection of a second thumbnail in the second frame, a second editable preview image is displayed in the third frame (step 170). Referring back to FIG. 14, image engine 96 may be responsible for generating the first and second editable preview images while display engine 98 may be responsible for causing the display of those images in steps 168 and 170. Looking at FIG. 10, a user has selected a first thumbnail 38a in second frame 74 causing a display of a first editable preview image 80 in third frame 76. Looking at FIG. 12, the user has selected a second thumbnail 38b in second frame 74 causing a display of a second editable preview image 88 in third frame 76.

With respect to steps 162 and 164 of FIG. 17, the first product control may correspond to a single mage product while the second product control may correspond to a multi-image product. FIGS. 3-9 provide examples. Product control 40c is for a single image product. Product control 40d is for a multi-image product. With respect to step 166 of FIG. 18, causing a display of thumbnails in the second frame then involves causing a display of a first thumbnail reflective of the single image product and causing a display of a grouping of second thumbnails reflective of the multi-image product. Each of the second thumbnails in the grouping is individually selectable to cause a display of a different editable preview image in the third frame. Looking back to FIG. 12, first thumbnail 38k is reflective of a single image product, while grouping 84 of second thumbnails is reflective of a multi-image product. Within grouping 84 of second thumbnails, each second thumbnail 38b, 38c, 38f, 38g, 38h, and 38j is individually selectable. In FIG. 12, second thumbnail 38b has been selected causing a display of editable product preview image 88.

The user may manipulate the first and second product preview images displayed as a result of steps 168 and 170. Referring to FIGS. 10-13, controls 82 allow the user to crop and position a selected digital image. As a result, the first thumbnail in the second frame is modified to reflect the user's manipulation of the first editable product preview image. Likewise, the second thumbnail in the second frame is modified to reflect users manipulation of the second editable product preview image. Referring back to FIG. 14, image engine 96 may be responsible for modifying the thumbnails. Looking at FIG. 11, first thumbnail 38a′ has been modified to reflect the user's manipulation of preview image 80. Looking at FIG. 13, second thumbnail 38b′ has been modified to reflect the user's manipulation of preview image 88.

CONCLUSION: The diagrams of FIGS. 1-13 are used to depict exemplary environments, components, and user interface displays. Implementation, however, is not so limited. FIGS. 15-16 show the architecture, functionality, and operation of various embodiments. Various components illustrated in FIGS. 15-16 are defined at least in part as programs. Each such component, portion thereof, or various combinations thereof may represent in whole or in part a module, segment, or portion of code that comprises one or more executable instructions to implement any specified logical function(s). Each component or various combinations thereof may represent a circuit or a number of interconnected circuits to implement the specified logical function(s).

Also, the present invention can be embodied in any computer-readable media for use by or in connection with an instruction execution system such as a computer/processor based system or an ASIC (Application Specific Integrated Circuit) or other system that can fetch or obtain the logic from computer-readable media and execute the instructions contained therein. “Computer-readable media” can be any media that can contain, store, or maintain programs and data for use by or in connection with the instruction execution system. Computer readable media can comprise any one of many physical media such as, for example, electronic, magnetic, optical, electromagnetic, or semiconductor media. More specific examples of suitable computer-readable media include, but are not limited to, a portable magnetic computer diskette such as floppy diskettes or hard drives, a random access memory (RAM), a read-only memory (ROM), an erasable programmable read-only memory, or a portable compact disc.

Although the flow diagrams of FIG. 17-18 show specific orders of execution, the orders of execution may differ from that which is depicted. For example, the order of execution of two or more blocks may be scrambled relative to the order shown. Also, two or more blocks shown in succession may be executed concurrently or with partial concurrence. All such variations are within the scope of the present invention.

The present invention has been shown and described with reference to the foregoing exemplary embodiments. It is to be understood, however, that other forms, details and embodiments may be made without departing from the spirit and scope of the invention that is defined in the following claims.

What is claimed is:

1. A method comprising:
causing, in a first frame of a user interface, a display of thumbnails each corresponding to a digital image;
with the thumbnails displayed in the first frame, causing, in the user interface, a display of a series of product controls;
upon a user's selection of a first one of the product controls modifying the thumbnails to a first product preview format corresponding to the first product control; and
upon the user's selection of a second one of the product controls, modifying the thumbnails to a second product preview format corresponding to the second product control, the second product preview format differing from the first product preview format.

2. The method of claim 1, further comprising:
upon the users selection of the first product control and a first thumbnail, updating a list to identify a first product corresponding to the first product control and the first thumbnail; and
upon the user's selection of the second product control and the second thumbnail, updating the list to include a second product corresponding to the second product control and the second thumbnail.

3. The method of claim 2, wherein the first and second thumbnails are the same thumbnail and the first and second product controls are different.

4. The method of claim 2, comprising:
upon a user's selection of a workflow control, causing, in a second frame of the user interface, a display of thumbnails each corresponding to a different product included on the list;
causing, in a third frame of the user interface, a display of a first editable preview image upon a users selection of a first one of the thumbnails in the second frame; and
causing, in the third frame of the user interface, a display of a second editable preview image upon a users selection of a second one of the thumbnails in the second frame.

5. The method of claim 4, wherein the first product control corresponds to a single image product and the second product control corresponds to a multi-image product and causing, in a second frame of the user interface, a display of thumbnails each corresponding to each product included on the list comprises:
causing a display of a first thumbnail reflective of the single image product; and
causing a display of a grouping of second thumbnails each reflective of an image in the multi-image product.

6. The method of claim 5, wherein causing a display of a grouping of second thumbnails comprises causing a display of a grouping of second thumbnails such that each of the second thumbnails is individually selectable to cause a display of a different editable preview image in the third frame of the user interface.

7. The method of claim 4, further comprising;
modifying the first thumbnail in the second frame to reflect a user's manipulation of the first editable product preview image in the third frame; and
modifying the second thumbnail in the second frame to reflect the user's manipulation of the second editable product preview image in the third frame.

8. A computer readable medium storing computer executable instructions that when executed implement a method that includes:
causing, in a first frame of a user interface, a display of thumbnails each representing a digital image;
with the thumbnails displayed in the first frame, causing, in the user interface, a display of a series of product controls;
upon a user's selection of a first one of the product controls modifying the thumbnails to a first product preview format corresponding to the first product control; and
upon the users selection of a second one of the product controls, modifying the thumbnails to a second product preview format corresponding to the second product control, the second product preview format differing from the first product preview format.

9. The medium of claim 8, wherein the method includes:
upon the users selection of the first product control and a first thumbnail, updating a list to identify a first product corresponding to the first product control and the first thumbnail; and
upon the users selection of the second product control and the second thumbnail, updating the list to include a second product corresponding to the second product control and the second thumbnail.

10. The medium of claim 9, wherein: the first and second thumbnails are the same thumbnail and the first and second product controls are different.

11. The medium of claim 9, wherein the method includes:
upon a user's selection of a workflow control, causing, in a second frame of the user interface, a display of thumbnails each corresponding to a different product included on the list;
causing, in a third frame of the user interface, a display of a first editable preview image upon a users selection of a first one of the thumbnails in the second frame; and
causing, in the third frame of the user interface, a display of a second editable preview image upon a users selection of a second one of the thumbnails in the second frame.

12. The medium of claim 11, wherein the first product control corresponds to a single image product and the second product control corresponds to a multi-image product and wherein causing, in a second frame of the user interface, a display of thumbnails each corresponding to each product Included on the list comprises:
causing a display of a first thumbnail reflective of the single image product; and
causing a display of a grouping of second thumbnails each reflective of an image in the multi-image product.

13. The medium of claim 12, wherein causing a display of a grouping of second thumbnails comprises causing a display of a grouping of second thumbnails such that each of the second thumbnails is individually selectable to cause a display of a different editable preview image in the third frame of the user interface.

14. The medium of claim 11, wherein the method includes:
modifying the first thumbnail in the second frame to reflect a user's manipulation of the first editable product preview image in the third frame; and
modifying the second thumbnail in the second frame to reflect the user's manipulation of the second editable product preview image in the third frame.

15. A system, comprising an image engine, a display engine, and a command engine, wherein:
the image engine is configured to generate a thumbnails each corresponding to one of a plurality of digital images;
the display engine is configured cause a display of the thumbnails in a first frame of a graphical user interface together with a display of product controls;
the command engine is configured to detect a user's selections from among the thumbnails and the product controls; and
the image engine is configured to:
upon detection by the command engine of a user's selection of a first one of the product controls, modify the thumbnails to a first product preview format corresponding to the first product control; and
upon detection by the command engine of the user's selection of a second one of the product controls, modify the thumbnails to a second product preview format corresponding to the second product control, the second product preview format differing from the first product preview format.

16. The system of claim 15, wherein the image engine is configured to:
upon the user's selection of the first product control and a first thumbnail, update a list to identify a first product corresponding to the first product control and the first thumbnail; and
upon the user's selection of the second product control and the second thumbnail, updating the list to include a second product corresponding to the second product control and the second thumbnail.

17. The system of claim 16, wherein:
the display engine is configured to cause a display of a workflow control in the user interface;
the command engine is configured to detect the user's selection of the workflow control and the user's selection from among thumbnails in a second frame of the user interface;
the display engine is configured to:
upon the user's selection of the workflow control, cause, in the second frame of the user interface, a display of thumbnails each corresponding to a different product included on the list;
cause, in a third frame of the user interface, a display of a first editable preview image upon a user's selection of a first one of the thumbnails in the second frame; and
cause, in the third frame of the user interface, a display of a second editable preview image upon a user's selection of a second one of the thumbnails in the second frame.

18. The system of claim 17, wherein the first product control corresponds to a single image product and the second product control corresponds to a multi-image product and wherein the display engine is configured to cause the display of the thumbnails each corresponding to each product included on the list by:
causing a display of a first thumbnail reflective of the single image product; and
causing a display of a grouping of second thumbnails each reflective of an image in the multi-image product.

19. The system of claim 18, wherein the display engine is configured to cause the display of the grouping of second thumbnails by causing a display of a grouping of second thumbnails such that each of the second thumbnails is individually selectable to cause a display of a different editable preview image in the third frame of the user interface.

20. The system of claim 17, wherein the image engine is configured to:
modify the first thumbnail in the second frame to reflect a user's manipulation of the first editable product preview image in the third frame; and
modify the second thumbnail in the second frame to reflect the user's manipulation of the second editable product preview image in the third frame.
